(19) United States
(12) Patent Application Publication
(10) Pub. No.: US 2005/0216911 A1
(43) Pub. Date: Sep. 29, 2005

(54) Deployment method and system for multiple remote computers

(76) Inventors: Chin-Tsai Yen, Tu Chen City (TW); Kai-Feng Chiu, Taipei Hsien (TW); Chun-Ping Lin, Taipei Hsien (TW); Kuo-Yi Lee, Luchou City (TW)

Correspondence Address: RABIN & BERDO, P.C., Suite 500, 1101 14 Street, N.W., Washington, DC, 20005, US

(21) Appl. No.: 11/032,070

(22) Filed: Jan. 11, 2005

(30) Foreign Application Priority Data
Mar. 26, 2004 (TW) 93108427

(51) Int. Cl. G06F 9/445

(52) U.S. Cl. 717/176; 717/171

(57) ABSTRACT

Multiple remote computers, a PXE server, a DHCP server, and a deployment server are connected to a network. An administrator assigns certain remote computers to be employed, and these computers are rebooted in a network boot mode. Afterwards, a client program is downloaded to each of these remote computers from the PXE server with the help of the DHCP server. These client programs start to communicate with the deployment server for receiving a series of multicast deployment packets. These client programs use the contents in the deployment packets to build a system environment for these remote computers. Disk images, configurations of BIOS and CMOS of these remote computers are backed up in the deployment server in advance so that these remote computers can be employed efficiently when necessary.

### RELATED APPLICATIONS

The present application is based on, and claims priority from, Taiwan Application Serial Number 93108427, filed Mar. 26, 2004, the disclosure of which is hereby incorporated by reference herein in its entirety.

### BACKGROUND OF THE INVENTION

1. Field of Invention

The invention relates to a deployment method and system for remote computers and, in particular, to a method and system that can simultaneously deploy multiple remote computers and have the restoration and backup functions.

2. Related Art

With great advance in computer technology, various kinds of general-purpose and special-purpose computers are widely used in offices and factories. Through the network, computers in remote factories can be connected together to achieve specific tasks. For example, even a small-size factory often has hundreds of computers with different purposes. If the system is damaged due to viruses or other reasons, the manager has to reinstall systems on these computers.

A conventional method of restoring the system is to reinstall the operating system, utilities, along with user's data into the computers directly. However, this is very time-consuming and will impose an extra cost to the business.

An improved method is to back up a disk image of the computer. Once the computer system is damaged and has to be reinstalled, the disk image is reloaded back to the computer disk. This is more efficient. However, if the computer is damaged so that it cannot directly access the previously stored disk image data, the other method is provided to load a small system using an optical disk, floppy disk, or network for restoring the backup data. However, it still takes a lot of manpower and time, especially if there are many computers to be repaired. For example, if a thousand computers of a bank distributed at different locations are damaged by a virus, it will take a very long time to restore the system using the conventional method. Thus, it will be a serious problem and a great loss for the bank.

Although there are many so-called network boot or control software programs, they still do not have the functions of automatically backing up and simultaneously restoring multiple computers. Consequently, it is of great benefit and need to system managers if one can find an efficient backup and restoration method under existing software and hardware structure in order to deploy multiple remote computers.

### SUMMARY OF THE INVENTION

An objective of the invention is to provide a method and system that can quickly deploy multiple computers.

According to an embodiment of the invention, the disclosed method includes at least the following steps. First, several remote computers are rebooted in a network boot mode. This can be set remotely via an operating interface. A client program is downloaded to each of these remote computers in the PXE mode. These client programs start to communicate with the deployment server for receiving deployment data. The deployment data are divided into a series of deployment packets, each of which has a packet number. If some deployment packets are lost, they can be downloaded again according to their packet numbers. The deployment data can be disk images, BIOS contents, and values in the CMOS data setting. Therefore, when the remote computers obtain the deployment data, they can perform system deployment accordingly.

In practice, the deployment packets are further packaged into UDP packets so that the deployment data can be more efficiently sent to multiple remote computers through multicast transmissions along with a mobile transmission window. Moreover, if some of the remote computers have trouble receiving the deployment data, they can be neglected in the beginning while others being deployed in order not to slow down the deployment.

One can also use the same packet and protocol to automatically back up the disk image, BIOS or CMOS data of the remote computers into the deployment server for future restoration or reinstallation.

Therefore, the invention has at least the following advantages. First, the manager does not need to physically go to the remote computers and use optical or floppy disks to reinstall the system. The manager can quickly deploy multiple computers through an operating interface. Secondly, the deployment process is virtually automatic. Moreover, the structure enables one to back up data on remote computers to the deployment server. In other words, the disclosed system and method does not only deploy multiple computers efficiently, it further performs backup operations for the manager to conveniently manage multiple remote computers.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a schematic view of the deployment according to an embodiment of the invention;

FIG. 2 is a schematic flowchart of the disclosed deployment method;

FIG. 3 shows how the client program is downloaded to a remote computer;

FIGS. 4A and 4B are examples of a deployment packet;

FIG. 5 is a flowchart of the deployment process; and

FIG. 6 is a flowchart of the system backup.

### DETAILED DESCRIPTION OF THE PREFERRED EMBODIMENT

In the specification, we use a preferred embodiment to explain how one can use the features of the invention to simultaneously deploy multiple remote computers and how to back up data in these remote computers. The deployment described here includes the first installation and/or setting on remote computers and the restoration of remote computers using the previously backed up data.

Deployment of Multiple Remote Computers:

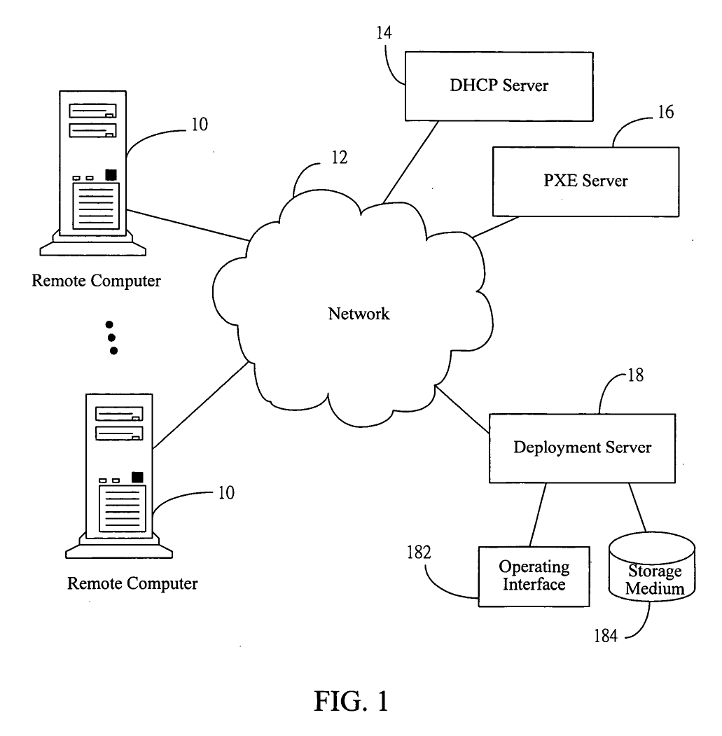

We use FIG. 1 to explain how several remote computers 10 are deployed according to a preferred embodiment of the invention.

First, the remote computers 10 are connected to a network 12. In addition, the network 12 is connected with a dynamic host configuration protocol (DHCP) server 14, a preboot execution environment (PXE) server 16, and a deployment server 18. The deployment server 18 has an operating interface 182 and a storage medium 184 that can be coupled to the deployment server directly or via the network 12.

In practice, the DHCP server 14, the PXE server 16, and the deployment server 18 can be installed on different machines or the same machine. Here, DHCP refers to the protocol that provides network IP addresses. The DHCP server 14 is a server that answers client requests, assigning the client one network IP from available addresses. Therefore, the system can automatically configure each client on the network 12 a network IP address that is not in conflict with others. PXE is a standard set by software and hardware manufacturers, including 3COM, HP, Dell, Phoneix, etc. When a remote computer 10 is rebooted via the network 12, it searches for the PXE server 16 on the network. It further obtains a program for reboot using the trivial file transfer protocol (TFTP).

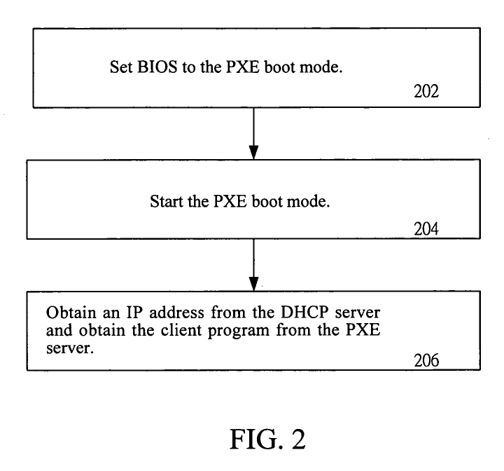

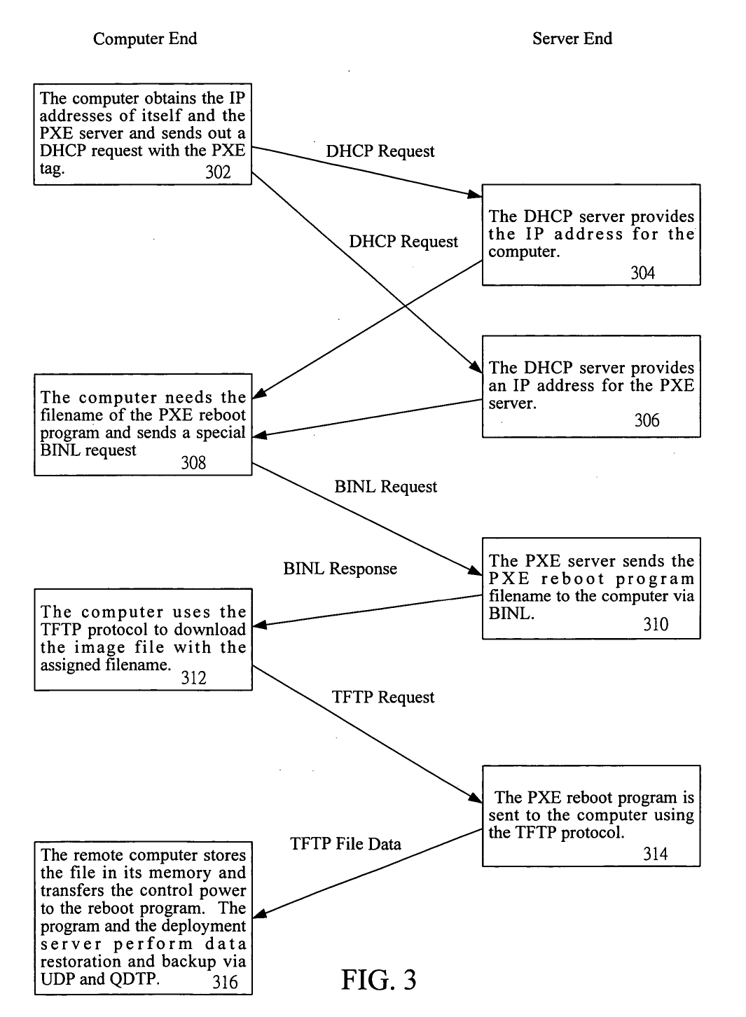

FIGS. 2 and 3 show that how a client program for restoration or first-time installation is downloaded to the remote computer 10 under the configuration of FIG. 1.

First, the basic input/output system (BIOS) of these remote computers 10 is set in the PXE boot mode (step 202). Afterwards, the PXE mode is started (step 204) for the remote computers 10 operate in the PXE mode. Under this mode, the remote computer 10 does not access the boot sector of the hard disk, but obtains a network IP address from the DHCP server 14. It further searches the PXE server 16 on the network, obtaining a client program using the TFTP protocol (step 206).

FIG. 3 shows in more detail how the PXE boot mode works. First, the remote computer 10 has to obtain network IP addresses for itself and the PXE server 16. Thus, it sends out a DHCP request with the PXE tag (step 302). Afterwards, the DHCP server 14 provides the remote computer 10 with an available network IP address (step 304). The DHCP server 14 also provides the remote computer 10 with a network IP address for the PXE server 16 (step 306). The remote computer 10 needs the filename of the reboot program. Therefore, it sends a special BINL request (step 308). Afterwards, the PXE server 16 sends the program filename to the remote computer 10 via BINL (step 310). Afterwards, the remote computer 10 uses the TFTP protocol to download the image file with the assigned filename, PXE reboot program is accordingly sent to the remote computer 10 with the TFTP protocol (step 312, step 314). The remote computer 10 stores the image file in its memory and transfers the control power to the image file program (step 316).

In the prior art, the image file in the PXE server 16 provides the program code for network booting. However, the invention cleverly uses this mechanism to perform a new function of deploying the remote computers 10 by letting them obtain a client program and using the client program to communicate with the deployment server 18 through a special deployment transfer protocol, called the quanta deployment transfer protocol (QDTP).

Before describing the QDTP, we first explain the network packet format used in the protocol.

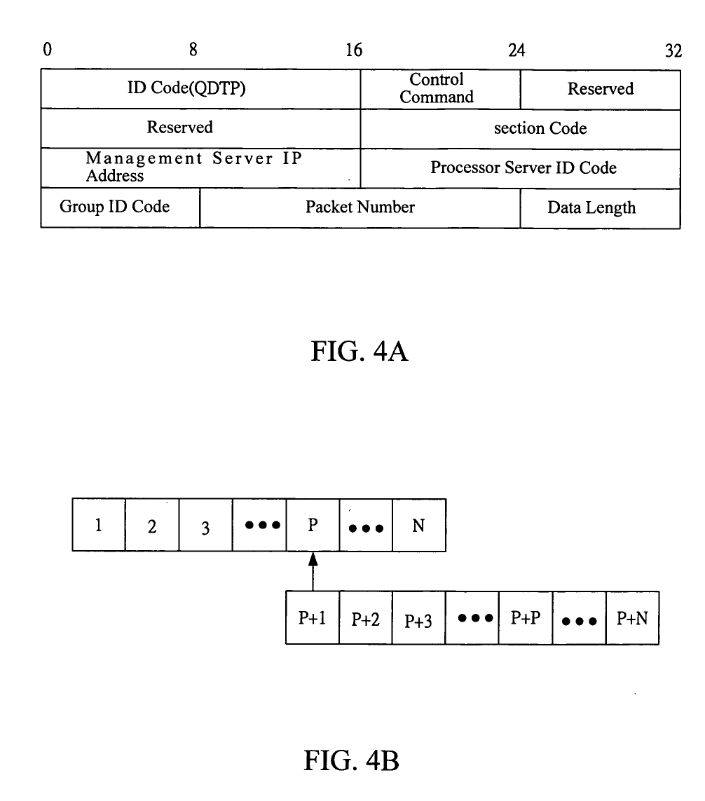

FIGS. 4A and 4B show an embodiment of the network packet. Each packet has: (1) an identification (ID) field to label a packet as the QDTP packet; (2) a control command, which stores a distinct control code; (3) a section code, which is used to store the progress in deployment and is updated by the client program during the process in order to facilitate the deployment control and data transmissions; (4) a management server IP address and a server ID code used to identify a remote computer 10; (5) a group ID code, which is used to label the group to which the remote computers 10 belong when they are deployed; (6) a packet number, which is used to represent the serial number of a data packet or the serial number of an ACK/NACK packet or request packet; and (7) a data length, which indicates the length of the data field after the packet header. The client program installed on the remote computers 10 and the deployment server 18 communicate-data and commands using the above-mentioned packet format for deployment.

The field of control commands can be set with different values with different meanings. For example, 0x8800 (Restore Send) means that the packet packed with deployment data is transmitted from the deployment server 18 to the client program. 0x8801 (ACK Request) means a multicast request packet from the deployment server 18. 0x8802 (ACK Response) means a packet in response to the ACK Request and is sent if the packet is received correctly. 0x8803 (NACK Response) means a packet in response to the ACK Request and is sent if the received packet number is smaller than the packet number of the ACK Request packet. The packet number field of the packet is filled with the last packet number being received. 0x8804 (Restore End) notifies the client program that the deployment is complete. 0x8805 (Restore Join) means a packet to be added to the deployment group that is sent by the client program during the initialization. 0x8806 (Restore Jack) means a response packet sent after the deployment server 18 receives the Restore Join packet.

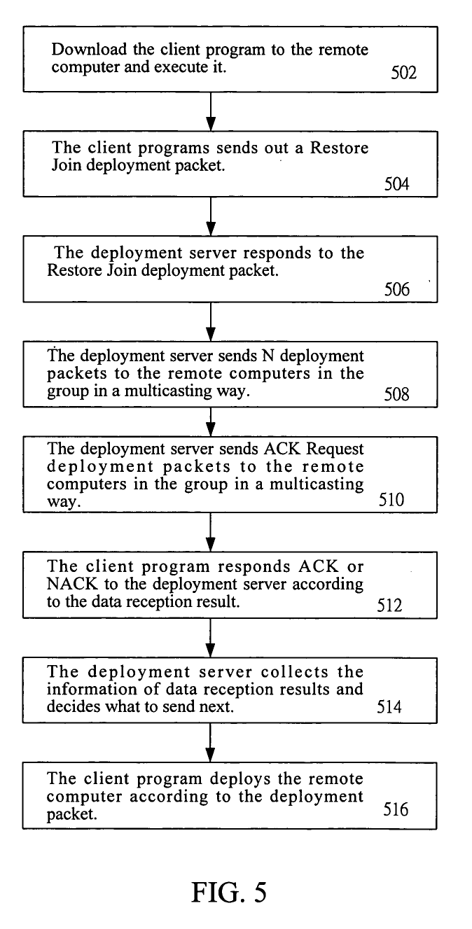

As shown in FIG. 5, the restoration process of the disclosed method starts by downloading the client program to the multiple remote computers 10 and executing the client program on the multiple remote computers 10 (step 502). The client program then sends out a Restore Join deployment packet to the deployment server 18 to request for an inclusion to the deployment group (step 504). After the deployment server 18 collects the Restore Join packets from the multiple remote computers 10, the Restore Jack deployment packets are simultaneously transmitted individually or in a multicasting way to the client programs (step 506).

The deployment server 18 transmits N deployment packets to all remote computers 10 in the deployment group (step 508). Here N is an arbitrarily assigned positive integer.

Please refer to FIG. 4B. Due to network communication quality and/or other problems, the multiple remote computers 10 may experience differently when receiving the N deployment packets. Therefore, the deployment server 18 transmits ACK Request deployment packets toward the remote computers 10 to request for reception confirmation (step 510). In the ACK Request deployment packet, N is filled into the deployment number in the packet format. After the client program receives the ACK Request deployment packet, it checks whether the packet number therein is received correctly. It is N in this example. If the client program receives P packets with P<N, then a NACK Response deployment packet is transmitted to the deployment server 18 (step 512) and P is filled into the packet number of the packet format. On the contrary, if all the N deployment packets are successfully received, the ACK Response deployment packet is returned to the deployment server 18 (step 512).

The deployment server 18 collects the ACK Response or NACK Response deployment packets returned by the client program on all the remote computers 10 to determine what packets to be transmitted in the next step (step 514). For example, suppose there are ten remote computers 10 in the deployment group. The deployment server 18 first continuously transmits 1000 deployment packets. When the deployment server 18 finds that two of the remote computers return NACK Response deployment packets with the packet numbers, for example 850 and 950, respectively, the deployment server 18 continues transmitting packets starting from the number 851 again.

After repeating the transmission of the above-mentioned deployment packets, the client program receives all the needed deployment packets and compiles them into the required deployment data for deploying the remote computers (step 516).

It should be noted that the deployment packet mentioned herein can be packed into a UDP (User Datagram Protocol) packet by the client program and transmitted using the UDP. The process can be reversed to decode multiple UDP packets into the original deployment data. Since the UDP supports multicasting transmissions, one only needs to assign multiple transmission addresses once when simultaneously deploying multiple remote computers 10. The multiple computer deployment can thus be sped up through multicasting transmissions according to the UDP.

Moreover, the system manager can deploy multiple remote computers 10 via the operating interface 182 of the deployment server 18. When some remote computers 10 almost or completely cannot receive the deployment packets, the deployment server 18 can notify the manager via the operating interface 182 or automatically pause the specific remote computers 10, preventing slowdown in the deployment of other remote computers 10. Besides, after the remote computers 10 receive all the deployment data, they are written into the disc, BIOS or CMOS data setting sector, completing the deployment process.

If the transmission is interrupted due to some reason (e.g. power failure or network breakdown), the manager can select to transmit data again using the operating interface 182, instead of transmitting them all over again. The continual transmission can be implemented by having the deployment server 18 record the QDTP sector number continuously and sending data from the next sector number.

Backup of Remote Computers:

As described before, the deployment of remote computers 10 is to write the disk image, BIOS or CMOS data into the corresponding disk, BIOS or CMOS data sections in the remote computers 10. In practice, after installing a remote computer we can back up its disk image or other data for future restoration. Another possibility is to use its disk image to install other remote computers 10.

Regarding backing up the disk image, BIOS, or CMOS data of a remote computer 10, we have at least the following methods.

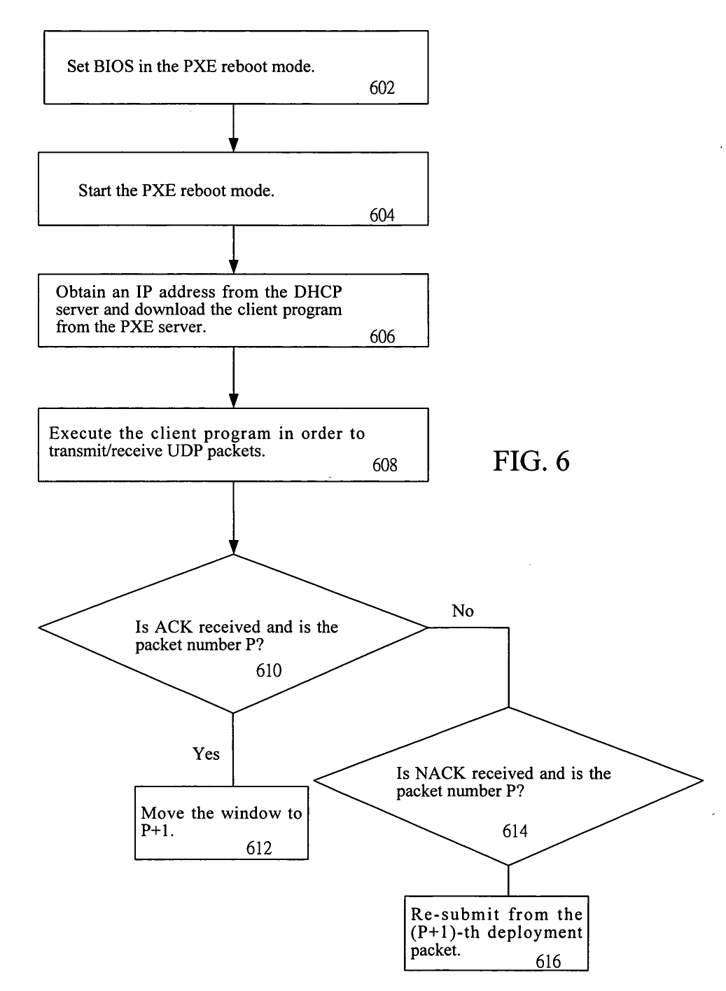

The first method utilizes the above-mentioned PXE structure, illustrated in FIG. 6. First, the remote computer 10 is set in a network reboot mode (steps 602, 604). A client program is downloaded using the PXE server 16 and the DHCP server 14 (step 606). The remote computer 10 executes the client program to read its disk image and to communicate with the deployment server 18 (step 608). The disk image of the remote computer 10 is packaged into a QDTP packet as shown in FIG. 4A. The deployment server 18 determines whether the packet is received correctly (step 610). If so, the packet transmission process continues (step 612); otherwise, the packet is re-submitted (steps 614, 616).

The second method does not use the PXE structure during the backup process. Instead, a client program for backup is written using a utility installed on the operating system and executed on the remote computer 10. The client program can also communicate with the deployment server 18 using the QDTP and related packet formats. The advantage of this method is to be able to call functions provided by the operating system, simplifying the complication in programming. Moreover, this method can be implemented by multitasking with other utilities on the remote computer 10 without interrupting their jobs.

Of course, when backing up data on the remote computer 10, the above-mentioned function of resuming transmissions can be used. In other words, since the QDTP packet format records the QDTP section number, the manager can select to resume data transmissions without starting all over if the backup process is interrupted for some reason. The backup process is thus more efficient.

When using the QDTP packet in FIG. 4A, different actions can be achieved by setting the control command field in different ways. For example, 0x0000 (Backup Send) means a packet wrapped with backup data to be sent from the client program to the deployment server. 0x0001 (Backup ACK) notifies the deployment that the packet designated by the packet number has been correctly received. 0x0002 (Backup Header) notifies the deployment to start transmitting an image file header. 0x0003 (Backup Terminate) notifies the deployment server that the backup process is over.

Others:

The remote computer 10 herein is not limited to the general-purpose computer, but includes various kinds of servers and computer modules (e.g. the server blade installed on a frame) instead. Moreover, the above-mentioned operation uses the example of restoring a system; the same mechanism can be applied to the backup process of transmitting the disk image, the BIOS data and the CMOS data settings from a remote computer 10 to the deployment server 18.

The disclosed mechanism has the ability of resuming transmissions and multicasting transmissions. The manager does not need to go to the computers in person. The invention can quickly deploy and back up remote computers. Therefore, it is a great relief for managers who need to take care of many computers. It also prevents great loss due to the system breakdown and a long time in system restoration.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method of deploying remote computers, comprising the steps of:
using a network reboot mode to deploy at least one remote computer;
downloading a client program to the remote computer;
downloading deployment data from a deployment server to the remote computer according to the client program, wherein the deployment data are divided into a plurality of deployment packets and each of which has a packet number;
re-transmitting unsent deployment packets when some of the deployment packets are not successfully received; and
deploying the remote computer using the deployment data.

2. The method of claim 1, wherein the network reboot mode is a PXE (Preboot execution Environment) mode.

3. The method of claim 2, wherein the remote computer uses DHCP (Dynamic Host Configuration Protocol) and TFTP (Trivial File Transfer Protocol) to read the client program from a PXE server via the network.

4. The method of claim 3, wherein the client program and the deployment server transmit data using a special deployment transfer protocol, called QDTP (Quanta Deployment Transfer Protocol), and the deployment includes a restoration step and a backup step.

5. The method of claim 4, wherein the QDTP is used to package the deployment packets into a multicasting packet in the restoration step and all the remote computers to be deployed receive the multicasting packet, each of the packets being packaged using a specific multicasting address and sent to all the remote computers in a one-to-many way.

6. The method of claim 4, wherein the QDTP is used to perform one-to-one transmissions of the deployment packets between the client program and the deployment server.

7. The method of claim 4, wherein at least one of the remote computers transmits to the deployment server a response packet that contains the values of the packet numbers of the deployment packets.

8. The method of claim 7, wherein the deployment server uses the values of the response packet to determine which of the deployment packets that have not been received by the remote computer are to be re-transmitted.

9. The method of claim 1, wherein one of the remote computers is given up for deployment when it is unable to successfully receive the deployment packets more than a predetermined number of times.

10. The method of claim 1 further comprising the step of the client program's writing data in the deployment packets into at least one disk drive of at least one of the remote computers.

11. The method of claim 1 further comprising the step of the client program's writing data in the deployment packets into the CMOS setting section of at least one of the remote computers.

12. The method of claim 1 further comprising the step of the client program's updating the BIOS of the remote computer.

13. The method of claim 1 further comprising the step of transmitting a disk image from at least one of the remote computers to the deployment server using the QDTP for backup.

14. A computer deployment system for deploying at least one remote computer connected to a network, comprising:
a PXE server, which is connected to the network for storing a client program; wherein the remote computer receives and executes the client program when it is turned on in the PXE mode; and
a deployment server, which is connected to the network for storing deployment data;
wherein the deployment server and the client program on the computer to be processed communicate with each other, the deployment data are divided into a plurality of deployment packets before transmissions, and if some of the deployment packets are lost the deployment server performs a re-transmission according to a packet reception status of the client program.

15. The system of claim 14, wherein the client program and the deployment server transmit data using a special deployment transfer protocol, called the QDTP (Quanta Deployment Transfer Protocol), and the deployment includes a restoration step and a backup step.

16. The system of claim 15, wherein the QDTP is used to package the deployment packets into a multicasting packet in the restoration step and all the remote computers to be deployed receive the multicasting packet, each of the packets being packaged using a specific multicasting address and sent to all the remote computers in a one-to-many way.

17. The system of claim 15, wherein the QDTP is used to perform one-to-one transmissions of the deployment packets between the client program and the deployment server.

18. The system of claim 15, wherein at least one of the remote computers transmits to the deployment server a response packet that contains the values of the packet numbers of the deployment packets.

19. The system of claim 18, wherein the deployment server uses the values of the response packet to determine which of the deployment packets that have not been received by the remote computer are to be re-transmitted.

20. The system of claim 14, wherein one of the remote computers is given up for deployment when it is unable to successfully receive the deployment packets more than a predetermined number of times.

21. The system of claim 14, wherein the client program writes data in the deployment packets into at least one disk drive of at least one of the remote computers.

22. The system of claim 14, wherein the client program writes data in the deployment packets into the CMOS setting section of at least one of the remote computers.

23. The system of claim 14, wherein the client program updates the BIOS of the remote computer.

24. The system of claim 14, wherein a disk image of at least one of the remote computers is transmitted to the deployment server by the client program for backup.
